(19) United States
(12) Patent Application Publication
(10) Pub. No.: US 2024/0168048 A1
(43) Pub. Date: May 23, 2024

(54) DEVICE OF AUTOMATICALLY DETECTING NUCLEIC ACID AND METHOD OF AUTOMATICALLY DETECTING NUCLEIC ACID

(71) Applicant: SANSURE BIOTECH INC., Changsha (CN)

(72) Inventors: Lizhong DAI, Changsha (CN); Yaping XIE, Changsha (CN); Diansu ZHENG, Changsha (CN); Qi CHEN, Changsha (CN); Hongli YAO, Changsha (CN)

(73) Assignee: SANSURE BIOTECH INC., Changsha (CN)

(21) Appl. No.: 18/431,023

(22) Filed: Feb. 2, 2024

Related U.S. Application Data
(63) Continuation of application No. PCT/CN2022/110255, filed on Aug. 4, 2022.

(30) Foreign Application Priority Data
Aug. 4, 2021 (CN) 202121805234.5
Dec. 31, 2021 (CN) 202111679528.2
Dec. 31, 2021 (CN) 202123429676.7

(51) Int. Cl. G01N 35/10; G01N 35/02; G01N 35/04

(52) U.S. Cl. CPC G01N 35/1002; G01N 35/021; G01N 2035/0403; G01N 2035/0429

(57) ABSTRACT

Disclosed is a device of automatically detecting nucleic acid, including: a fixing frame; a cartridge positioning assembly having a cartridge loading position configured to position a cartridge; a lifting assembly including a lifting base configured to be controllably moved toward or away from the cartridge positioning assembly in a first direction; a rotating assembly including a rotating member capable of controllably rotating relative to the lifting base around a rotation axis parallel to the first direction; and a liquid transferring assembly including a connecting portion configured to connect to a tip. The liquid transferring assembly is capable of rotating with the rotating member to a position where the connecting portion is aligned with any liquid storing tank of the cartridge in the first direction, the liquid transferring assembly is capable of moving along with the lifting base to an inserting position or a disengaging position along the first direction.

### CROSS-REFERENCE TO RELATED APPLICATIONS

This application is a continuation of International Application No. PCT/CN2022/110255, filed on Aug. 4, 2022, which claims priority to Chinese Patent Application No. 202111679528.2, filed on Dec. 31, 2021, Chinese Patent Application No. 202123429676.7, filed on Dec. 31, 2021, and Chinese Patent Application No. 202121805234.5, filed on Aug. 4, 2021. All of the aforementioned patent applications are hereby incorporated by reference in their entireties.

### TECHNICAL FIELD

The present disclosure relates to the field of biological detection technology, in particular to a device of automatically detecting nucleic acid and a method of automatically detecting nucleic acid.

### BACKGROUND

Nucleic acid detection generally adopts Polymerase Chain Reaction (PCR) technology. PCR technology is a molecular biological technology that amplifies specific deoxyribonucleic acid (DNA) sequences in vitro. Because PCR technology has the characteristics of strong specificity, high sensitivity, low purity requirements, simplicity and rapidity, it is widely used in nucleic acid detection and analysis.

When using PCR technology for nucleic acid detection, it is necessary to perform nucleic acid extraction and detection pretreatment on the sample. However, due to the complex process of nucleic acid extraction and detection pretreatment, each step needs to complete the transfer of samples or reagents, and the action process is relatively complicated. On the one hand, the degree of automation of the device is not high, requiring manual assistance. On the other hand, the device is complex, large in size, and takes up a lot of space.

### SUMMARY

According to some embodiments, a device of automatically detecting nucleic acid and a method of automatically detecting nucleic acid are provided.

A device of automatically detecting nucleic acid includes:
a fixing frame;
a cartridge positioning assembly mounted on the fixing frame and having a cartridge loading position configured to position a cartridge;
a lifting assembly including a lifting base provided on the fixing frame, where the lifting base is configured to be controllably moved toward or away from the cartridge loading position in a first direction;
a rotating assembly including a rotating member provided on the lifting base, where the rotating member is capable of controllably rotating relative to the lifting base around a rotation axis parallel to the first direction; and
a liquid transferring assembly mounted on the rotating member and including a connecting portion configured to connect to a tip, where the liquid transferring assembly is capable of rotating with the rotating member to a position where the connecting portion is aligned with any liquid storing tank of the cartridge in the first direction, the liquid transferring assembly is capable of moving along with the lifting base to an inserting position or a disengaging position along the first direction,
where when the liquid transferring assembly is moved to the inserting position, the tip on the connecting portion is inserted into a liquid storing tank of the cartridge; and when the liquid transferring assembly is moved to the disengaging position, the tip on the connecting portion disengages from the liquid storing tank of the cartridge.

In an embodiment, the rotating assembly further includes a toggling rod eccentrically mounted on a side of the rotating member facing the cartridge loading position, the toggling rod is capable of moving along with the lifting base in the first direction to a position where the toggling rod is inserted into or disengaged from the cartridge, and when the toggling rod is inserted into the cartridge, the toggling rod is capable of driving the cartridge to rotate along with the rotating member.

In an embodiment, the liquid transferring assembly is further capable of rotating along with the rotating member to a position where the connecting portion is aligned with a tip cavity of the cartridge in the first direction, and when the liquid transferring assembly is moved along with the lifting base to the inserting position, the connecting portion is capable of engaging with or disengaging from the tip in the tip cavity.

In an embodiment, the lifting base passes through a first position, a second position, and a third position in sequence during moving towards the cartridge; when the lifting base is positioned in the first position, the toggling rod and the connecting portion are disengaged from the cartridge; when the lifting base is positioned in the second position, the liquid transferring assembly is positioned at the disengaging position, and the toggling rod is inserted into the cartridge; and when the lifting base is positioned in the third position, the liquid transferring assembly is positioned in the inserting position.

In an embodiment, the liquid transferring assembly is further capable of rotating along with the rotating member to a position where the connecting portion is aligned with a plunger hole of the cartridge in the first direction, and the liquid transferring assembly is capable of moving along with the lifting base toward the cartridge along the first direction to be inserted in the plunger hole, and pushing a plunger in the plunger hole.

In an embodiment, the lifting assembly further includes a driving mechanism; the driving mechanism includes a linear driving member mounted on the fixing frame and connected to the lifting base, the linear driving member is configured to drive the lifting base to move relative to the fixing frame along the first direction; or the driving mechanism includes a screw rod, a lift driving member and a nut, the screw rod is rotatably connected to the fixing frame around an axis thereof, the axis of the screw rod is parallel to the first direction, the lift driving member is mounted to the fixing frame and is connected to the screw rod, and the nut is connected to the screw rod and fixed to the lifting base.

In an embodiment, the lifting assembly further includes a guiding rod, the guiding rod is fixed to the fixing frame and extends in the first direction, the lifting base is slidably connected to the guiding rod; the lifting base is provided with a first sensing piece, two second photoelectric sensors configured to detect the first sensing piece are mounted on the fixing frame, the two second photoelectric sensors are arranged at intervals along the first direction, and during the movement of the lifting base in the first direction, the first sensing piece is driven to move between the two second photoelectric sensors.

In an embodiment, the rotating assembly further includes a rotary driving mechanism, the rotary driving mechanism includes a rotary driving member, a driving pulley, a driven pulley, and a conveyor belt; the rotary driving member is mounted on the fixing frame, and the driving pulley is connected to an output shaft of the rotary driving member, the driven pulley is mounted on the rotating member and is capable of rotating synchronously with the rotating member, the conveyor belt is sleeved between the drive pulley and the driven pulley.

In an embodiment, the device further includes a nucleic acid detecting module provided on the fixing frame, where the nucleic acid detecting module is arranged corresponding to the cartridge and is configured to perform nucleic acid detection on nucleic acid-containing liquid formed in the cartridge.

In an embodiment, the cartridge positioning assembly includes: a base; a tray assembly including a tray provided on the base and a clamping mechanism provided on the tray, where the tray is configured to be controllably moved relative to the base to a house-in position and a house-out position, and the cartridge loading position is provided on the tray; and a driving member provided corresponding to the house-in position, where when the tray is moved to the house-in position, the driving member abuts the clamping mechanism and drives the clamping mechanism to clamp the cartridge on the cartridge loading position.

In an embodiment, the clamping mechanism includes a clamping block and an elastic member, the clamping block is connected to the tray and is capable of moving toward or away from the cartridge loading position, the elastic member abuts against the tray and the clamping block; when the tray is moved to the house-in position, the driving member abuts against the clamping block, and pushes the clamping block to move toward the cartridge loading position to abut against the cartridge, and the elastic member provides a resilience force to enable the clamping block to have a tendency to move away from the cartridge loading position.

In an embodiment, two clamping mechanisms and two driving members are provided, the two clamping mechanisms are respectively located on opposite sides of the cartridge loading position, and are in one-to-one correspondence with the two driving members; when the tray moves to the house-in position, the two clamping blocks are pushed by the two driving members correspondingly to clamp the cartridge.

In an embodiment, the cartridge positioning assembly further includes a driving assembly provided on the base, the driving assembly is capable of driving the tray to move between the house-in position and the house-out position.

In an embodiment, the cartridge includes: a liquid storing assembly provided with a tip chamber, an injecting hole, and a plurality of liquid storing tanks on a side thereof; a rotating cover connected to a side of the liquid storing assembly where the liquid storing tank is provided; a reacting chamber detachably connected to the liquid storing assembly and being in communication with the injecting hole; a liquid dispensing member extending through the rotating cover along the first direction and being capable of reciprocating along the first direction; where the rotating cover is capable of rotating relative to the liquid storing assembly around an axis extending in the first direction to enable the liquid dispensing member to be aligned with and extend into the tip chamber, the injecting hole or any one of the liquid storing tanks in the first direction.

In an embodiment, the cartridge further includes a sealing rod extending through the rotating cover along the first direction, and the sealing rod is movable in the first direction to extend into the injecting hole.

In an embodiment, the cartridge further includes a rotating shaft, the liquid storing assembly is provided with a rotating shaft hole extending along the first direction, one end of the rotating shaft is connected to the rotating cover, and the other end of the rotating shaft is rotatably connected to the rotating shaft hole.

In an embodiment, the rotating cover is provided with a sample adding hole, and the sample adding hole is configured to communicate with the liquid storing tank and an external environment.

In an embodiment, the cartridge further includes a sealing ring, the sealing ring is provided outside the liquid storing assembly along a circumferential direction and is located between the liquid storing assembly and the rotating cover, and the sealing ring is configured to seal a gap between the liquid storing assembly and the rotating cover.

In an embodiment, the reacting chamber includes a reacting chamber liquid inlet pipe and a reacting chamber liquid discharge pipe, the liquid storage assembly is provided with a reacting chamber liquid inlet channel and a reacting chamber liquid discharge channel that are in communication with the injecting holes, respectively; when the reacting chamber is inserted into the liquid storage assembly, the reacting chamber liquid inlet pipe is in communication with the reacting chamber liquid inlet channel, and the reacting chamber liquid discharge pipe is in communication with the reacting chamber liquid discharge channel.

A method of detecting nucleic acid using the device of automatically detecting nucleic acid as described above includes:
a, loading the cartridge on the cartridge loading position of the cartridge positioning assembly, where each liquid storing tank of the cartridge is pre-installed with samples and various reagents for nucleic acid extraction and detection pretreatment;
b, driving the liquid transferring assembly to rotate through the rotating member until the connecting portion of the liquid transferring assembly is selectively aligned with a liquid storing tank of the cartridge;
c, driving the liquid transferring assembly through the lifting base to enable a tip on the connecting portion to insert into or disengage from the liquid storing tank successively, and when the tip on the connecting portion are inserted into the liquid storing tank, sucking the reagent in the liquid storing tank or injecting the reagent into the liquid storing tank through the tip;
d, performing step b and step c cyclically to transfer reagents in each liquid storing tank and mixing reagents with the sample, until the nucleic acid extraction and detection pretreatment are completed to obtain nucleic acid-containing liquid; and
e, performing nucleic acid detection on the nucleic acid-containing liquid.

Details of one or more embodiments of the present disclosure are set forth in the following drawings and descriptions. Other features, objects and advantages of the present disclosure become apparent from the description, drawings and claims.

### BRIEF DESCRIPTION OF THE DRAWINGS

To illustrate the technical solutions according to the embodiments of the present invention or in the prior art more clearly, the accompanying drawings for describing the embodiments or the prior art are introduced briefly in the following. Apparently, the accompanying drawings in the following description are only some embodiments of the present invention, and persons of ordinary skill in the art can derive other drawings from the accompanying drawings without creative efforts.

FIG. 1 is a front view of a device of automatically detecting nucleic acid according to an embodiment.

FIG. 2 is a perspective view of the device of automatically detecting nucleic acid shown in FIG. 1.

FIG. 3 is a perspective view of a cartridge positioning assembly and a nucleic acid detecting module of the device of automatically detecting nucleic acid shown in FIG. 1.

FIG. 4 is a perspective view of a rotating assembly and a lifting assembly of the device of automatically detecting nucleic acid shown in FIG. 1.

FIG. 5 is a flowchart of a method of automatically detecting nucleic acid in an embodiment.

FIG. 6 is a flowchart of a step of picking up the tip in the method of automatically detecting nucleic acid in an embodiment.

FIG. 7 is a flowchart of a step of pushing a plunger to insert into an injection tank in the method of automatically detecting nucleic acid in an embodiment.

FIG. 8 is a perspective view of the cartridge positioning assembly of the device of automatically detecting nucleic acid shown in FIG. 1.

FIG. 9 is a front view of the cartridge positioning assembly shown in FIG. 8.

FIG. 10 is a top view of the cartridge positioning assembly shown in FIG. 8.

FIG. 11 is a top view of the cartridge positioning assembly shown in FIG. 8, with a cover omitted.

FIG. 12 is a right side view of the cartridge positioning assembly shown in FIG. 8.

FIG. 13 is a perspective view of a cartridge of the device of automatically detecting nucleic acid shown in FIG. 1.

FIG. 14 is an exploded view of a cartridge shown in FIG. 13.

FIG. 15 is a top view of a liquid storing assembly of the cartridge shown in FIG. 13.

FIG. 16 is a longitudinal sectional view of the cartridge shown in FIG. 13.

### DETAILED DESCRIPTION OF THE EMBODIMENTS

The present disclosure will now be described in detail with reference to the accompanying drawings and embodiments in order to make the objects, technical solutions, and advantages of the present disclosure more clear. It should be understood that the specific embodiments described herein are only for explaining the present disclosure, and not intended to limit the present disclosure.

In the description of the present disclosure, it should be understood that the terms “center”, “longitudinal”, “transverse”, “length”, “width”, “thickness”, “upper”, “lower”, “front”, “rear”, “left”, “right”, “vertical”, “horizontal”, “outer”, “clockwise”, “counterclockwise”, “axial”, “radial”, “circumferential” and other indicated orientations or positional relationships are based on the orientations or positional relationships shown in the accompanying drawings, and are only for the convenience of describing the present disclosure and simplifying the description, rather than indicating or implying the indicated device or elements must have a particular orientation, be constructed and operate in a particular orientation, so it should not be understood as a limitation of the invention.

In addition, the terms “first” and “second” are only used for descriptive purposes, and should not be construed as indicating or implying relative importance or implying the number of indicated technical features. Thus, a feature delimited with “first”, “second” may expressly or implicitly include at least one of that feature. In the description of the present disclosure, “plurality” means at least two, such as two, three, etc., unless otherwise expressly and specifically defined.

In the present disclosure, unless otherwise expressly specified and limited, the terms “installed”, “connection”, “connected”, “fixed” and other terms should be understood in a broad sense. For example, it may be a fixed connection or a detachable connection, or integrated. It can be a mechanical connection or an electrical connection. It can be directly connected or indirectly connected through an intermediate medium. It can be the internal connection of two elements or the interaction relationship between the two elements, unless otherwise specified limit. For those of ordinary skill in the art, the specific meanings of the above terms in the present invention can be understood according to specific situations.

In the present disclosure, unless otherwise expressly specified and limited, the first feature “above” or “below” the second feature may be in direct contact with the first and second features, or the first and second features may be in indirect contact through an intermediate medium. Moreover, the first feature being “above” and “over” the second feature may mean that the first feature is directly above or diagonally above the second feature, or it only means that the horizontal height of the first feature is higher than the second feature. The first feature being “below” of the second feature may mean that the first feature is directly below or obliquely below the second feature, or simply means that the horizontal height of the first feature is less than that of the second feature.

It should be noted that when an element is referred to as being “fixed to” or “disposed on” another element, it can be directly on the other element or an intervening element may also be present. When an element is referred to as being “connected” to another element, it can be directly connected to the other element or intervening elements may also be present. The terms “vertical”, “horizontal”, “upper”, “lower”, “left”, “right” and similar expressions used herein are for the purpose of illustration only and do not represent the only embodiment.

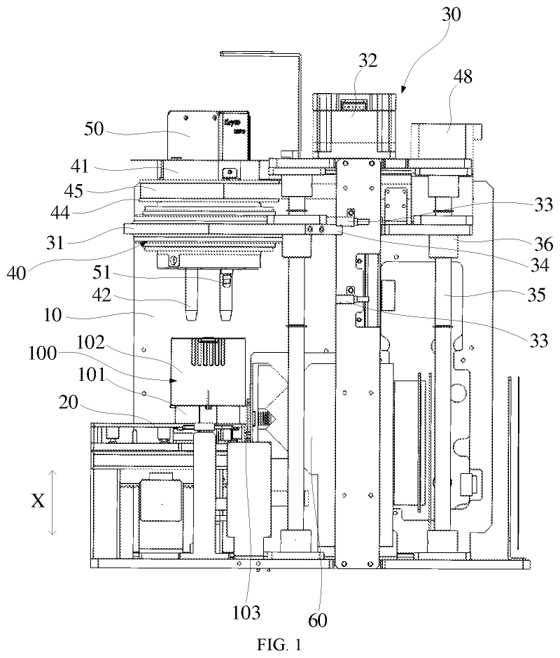

Referring to FIG. 1, an embodiment of the present disclosure provides a device of automatically detecting nucleic acid, which includes a fixing frame 10, a cartridge positioning assembly 20, a lifting assembly 30, a rotating assembly 40 and a liquid transferring assembly 50.

The cartridge positioning assembly 20 is mounted on the fixing frame 10 and has a cartridge loading position A (shown in FIG. 11) configured to position a cartridge 100. The lifting assembly 30 includes a lifting base 31 provided on the fixing frame 10. The lifting base 31 is capable of controllably moving toward or away from the cartridge positioning assembly 20 in a first direction X. The rotating assembly 40 includes a rotating member 41. The rotating member 41 is provided on the lifting base 31 and is capable of controllably rotating relative to the lifting base 31 around a rotation axis parallel to a first direction X.

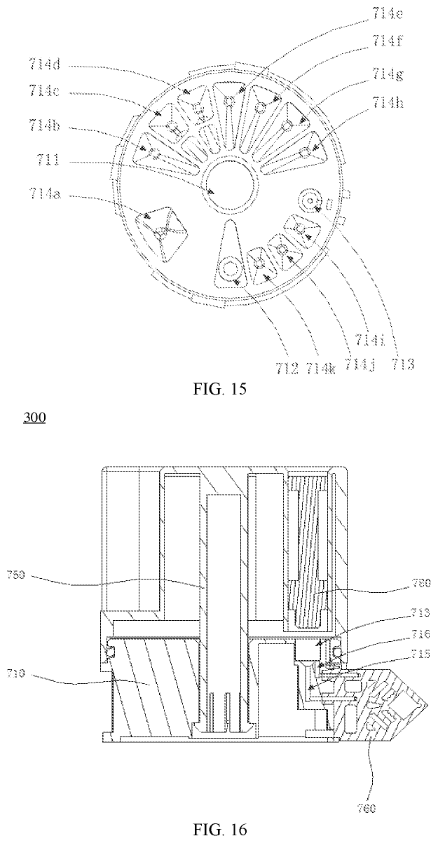

The liquid transferring assembly 50 is mounted on the rotating member 41, so that the liquid transferring assembly 50 can rotate together with the rotating member 41, and the rotating member 41 and the liquid transferring assembly 50 can move along the first direction X together with the lifting base 31. The liquid transferring assembly 50 has a connecting portion 51 configured to connect to a tip 106 (shown FIG. 3). The liquid transferring assembly 50 is capable of rotating with the rotating member 41 to a position where the connecting portion 51 is aligned with any liquid storing tank (shown in FIG. 15) of the cartridge 100 in the first direction X. The liquid transferring assembly 50 can move along with the lifting base 31 to an inserting position or a disengaging position along the first direction X. When the liquid transferring assembly 50 moves to the inserting position, the tip 106 on the connecting portion 51 is inserted into the liquid storing tank of the cartridge 100 aligned with the tip 106, thereby sucking or injecting reagent. When the liquid transferring assembly 50 moves to the disengaging position, the tip 106 on the connecting portion 51 disengages from the liquid storing tank of the cartridge 100 aligned with the tip 106.

In an embodiment, when the above-mentioned device of automatically detecting nucleic acid is used, firstly, samples, various reagents for nucleic acid extraction and detection pretreatment are respectively pre-loaded into the liquid storing tanks of the cartridge 100, and the cartridge 100 is positioned on the cartridge loading position A (shown in FIG. 11) of the cartridge positioning assembly 20.

Then, the rotating member 41 is rotated to drive the liquid transferring assembly 50 to rotate to enable the connecting portion 51 to be aligned with one liquid storing tank in the first direction X. Next, the lifting base 31 is controlled to move toward the cartridge 100 along the first direction X, and the tip 106 on the connecting portion 51 is aligned with and inserted into the liquid storing tank (i.e., the inserting position) to suck the reagent in the liquid storing tank. After the reagent is sucked, the lifting base 31 is controlled to move away from the cartridge 100 along the first direction X, so that the tip 106 on the connecting portion 51 disengages from the liquid storing tank (i.e., the disengaging position). Then, the rotating member 41 is rotated to drive the liquid transferring assembly 50 to rotate to enable the connecting portion 51 to be aligned with a liquid storing tank preloaded with a sample in the first direction X. Then, the lifting base 31 is controlled to move toward the cartridge 100 along the first direction X, the tip 106 on the connecting portion 51 is aligned with and inserted into the liquid storing tank preloaded with the sample (i.e., the inserting position), and the absorbed reagent is injected into the current liquid storing tank to mix the reagent with the sample. After the reagent is injected, the lifting base 31 is controlled to move away from the cartridge 100 along the first direction X, so that the tip 106 on the connecting portion 51 disengages from the liquid storing tank (i.e., the disengaging position). Then, as the same manner as described above, the sample is mixed with other reagent to achieve nucleic acid extraction and detection pretreatment. That is, nucleic acid-containing liquid is obtained to facilitate the nucleic acid detection of the nucleic acid-containing liquid.

In this way, the rotating member 41 and the liquid transferring assembly 50 are driven by the lifting base 31 to move along the first direction X to insert into or disengage from the liquid storing tank to achieve suction or injection of the reagent. The liquid transferring assembly 50 is driven to rotate by the rotating member 41, so that the tip 106 on the connecting portion 51 can be selectively aligned with any liquid storing tank, so as to facilitate the transferring of the reagent. In other words, it is only necessary to drive the liquid transferring assembly 50 to move along the first direction X and rotate around the rotation axis to realize nucleic acid extraction and detection pretreatment. It is not necessary to provide a drive structure for driving the cartridge 100 to move and/or rotate, which is beneficial to simplifying the device, and reduce the size of the device. In addition, the nucleic acid extraction, the detection pretreatment, and the nucleic acid detection can all be processed with a high degree of automation, which does not require manual intervention, reducing the error of test detection. The mixing of reagents is completed in the cartridge 100, thus reducing the pollution of aerosols and the harm to experimental personnel.

In an embodiment, the device of automatically detecting nucleic acid further includes a nucleic acid detecting module 60 arranged on the fixing frame 10. The nucleic acid detecting module 60 is arranged corresponding to the cartridge 100 and is configured to perform nucleic acid detection (e.g., fluorescence detection) on the nucleic acid-containing liquid obtained by the nucleic acid extraction and the detection pretreatment in the cartridge 100.

Referring to FIG. 3, in the embodiment, the cartridge 100 includes a cartridge body 101, a top cover 102, and a Polymerase Chain Reaction (PCR) tube 103. Each liquid storing tank is provided on the cartridge body 101, and the cartridge body 101 can be loaded on the cartridge loading position A of the cartridge positioning assembly 20 (shown in FIG. 11). The top cover 102 is located on the cartridge body 101, and is rotatable relative to the cartridge body 101. Specifically, the top cover 102 can be rotated to allow the connecting portion 51 to be aligned with any liquid storing tank on the cartridge body 101 in the first direction X (shown in FIG. 1). The top cover 102 is provided with a tip cavity 105 and a toggling hole 104. The tip cavity 105 is configured to accommodate the tip 106. When the tip 106 is accommodated in the tip cavity 105, an end of the tip 106 is extended into the liquid storing tank aligned with the tip cavity 105. The toggling hole 104 is configured to allow a toggling rod 42 (shown in FIG. 1) to be inserted.

Referring to FIG. 1 to FIG. 3, in an embodiment, the rotating assembly 40 further includes the toggling rod 42, and the toggling rod 42 is eccentrically mounted on a side of the rotating member 41 facing the cartridge loading position A (shown in FIG. 11), so that the toggling rod 42 can rotate with the rotating member 41 and also move along with the lifting base 31 in the first direction X. The toggling rod 42 is capable of moving along with the lifting base 31 in the first direction X to a position where the toggling rod 42 is inserted into or disengaged from the toggling hole 104 on the top cover 102 of the cartridge 100. When the toggling rod 42 is inserted into the toggling hole 104 on the top cover 102 of the cartridge 100, the toggling rod 42 is capable of driving the top cover 102 to rotate along with the rotating member 41 (the cartridge body 101 is fixed and cannot rotate with the top cover 102). In this way, the toggling rod 42 can drive the top cover 102 to rotate with the rotating member 41, so that the tip 106 on the connecting portion 51 can be aligned with any liquid storing tank in the first direction X, so as to transfer the reagent.

Specifically, in an embodiment, the liquid transferring assembly 50 is further capable of rotating along with the rotating member 41 to a position where the connecting portion 51 is aligned with the tip cavity 105 of the cartridge 100 in the first direction X.

When the connecting portion 51 is aligned with the tip cavity 105 of the cartridge 100 in the first direction X, and when the liquid transferring assembly 50 moves along with the lifting base 31 to an inserting position, the connecting portion 51 is capable of engaging with or disengaging from the tip 106 in the tip cavity 105. In this way, when the tip 106 needs to be picked up, the liquid transferring assembly 50 moves to the inserting position with the lifting base 31, so that the connecting portion 51 is inserted into the tip cavity 105 of the top cover 102 and presses the tip 106 in the tip cavity 105 to engage with the tip 106. That is, the tip 106 is picked up. When the tip 106 needs to be released, the liquid transferring assembly 50 moves to the inserting position with the lifting base 31, so that the connecting portion 51 drives the tip 106 to insert into the tip cavity 105 of the top cover 102, and presses the tip 106 to disengage the tip 106 from the connecting portion 51. That is, the tip 106 is released into the tip cavity 105 of the top cover 102.

In actual operation, when it is necessary to suck the reagent in a selected liquid storing tank or inject the sucked reagent into the selected liquid storing tank, the lifting base 31 moves toward the cartridge 100 along the first direction X until the toggling rod 42 is inserted into the toggling hole 104 on the top cover 102, the connecting portion 51 of the liquid transferring assembly 50 is inserted into the tip cavity 105 on the top cover 102 and connected to the tip 106. The rotating member 41 is controlled to rotate, so that the toggling rod 42 drives the top cover 102 to rotate relative to the cartridge body 101 until the tip cavity 105 is aligned with the selected liquid storing tank. Then, the lifting base 31 is controlled to move toward the cartridge 100 along the first direction X, so that the liquid transferring assembly 50 drives the tip 106 to be inserted into the selected liquid storing tank, and then sucks the reagent in the selected liquid storing tank or inject reagents into the selected liquid storing tank.

Specifically, in an embodiment, the lifting base 31 passes through a first position, a second position, and a third position in sequence during moving towards the cartridge 100. It should be noted that, the third position is closest to the cartridge 100, the first position is farthest from the cartridge 100, and the second position is between the first position and the third position. When the lifting base 31 moves to the first position, the toggling rod 42 and the connecting portion 51 of the liquid transferring assembly 50 are disengaged from the cartridge 100. That is, the toggling rod 42 is disengaged from the toggling hole 104 on the top cover 102, and the connecting portion 51 is disengaged from the tip cavity 105 of the top cover 102. When the lifting base 31 moves to the second position, the toggling rod 42 is inserted into the cartridge 100, and the liquid transferring assembly 50 is positioned at the disengaging position. That is, the tip 106 on the connecting portion 51 is inserted into the tip cavity 105 on the top cover 102, and the tip 106 on the connecting portion 51 is not inserted into the current liquid storing tank. At this time, the tip 106 does not interfere with the rotational movement of the top cover 102 relative to the cartridge body 101. When the lifting base 31 moves to the third position, the liquid transferring assembly 50 is in the inserting position. That is, the tip 106 on the connecting portion 51 is inserted into the current liquid storing tank from the tip cavity 105. At this time, the reagent can be injected into the liquid storing tank or the reagent in the liquid storing tank can be sucked.

In this way, when the reagent needs to be injected into the selected liquid storing tank or the reagent in the selected liquid storing tank needs to be sucked, firstly, the lifting base 31 moves toward the cartridge 100 from the first position along the first direction X until it move to the third position. At this time, the toggling rod 42 is inserted into the toggling hole 104 of the top cover 102 (an insertion depth is deep). The connecting portion 51 of the liquid transferring assembly 50 is inserted into the tip cavity 105, and presses the tip 106 so that the connecting portion 51 is connected to the tip 106. Then, the lifting base 31 moves away from the cartridge 100 along the first direction X from the third position until reaching the second position. At this time, the toggling rod 42 is still inserted in the toggling hole 104 of the top cover 102 (the insertion depth is shallow), and the liquid transferring assembly 50 drives the tip 106 on the connecting portion 51 to disengage from the liquid storing tank (at this time, the tip 106 is only located in the tip cavity 105, so that the tip 106 does not interfere with the rotational movement of the top cover 102 relative to the cartridge body 101). Then, the rotating member 41 is rotated, so that the toggling rod 42 drives the top cover 102 to rotate, and the liquid transferring assembly 50 also rotates with the rotating member 41 until the tip 106 on the liquid transferring assembly 50 is aligned with the selected liquid storing tank in the first direction X. Then, the lifting base 31 moves toward the cartridge 100 along the first direction X from the second position until it moves to the third position. At this time, the liquid transferring assembly 50 drives the tip 106 on the connecting portion 51 to be inserted into the selected liquid storing tank. The liquid transferring assembly 50 sucks the reagent in the selected liquid storing tank through the tip 106 or injects the reagent into the selected liquid storing tank.

It should be noted that as an embodiment, one of the liquid storing tanks of the cartridge body 101 is in communication with a detection tank of the PCR tube 103 (for the convenience of description, this liquid storing tank is named as an injection tank). The top cover 102 is provided with a plunger hole 107 with a plunger inside (not shown), so that the nucleic acid-containing liquid in the injection tank can be injected into the detection tank of the PCR tube 103 by the plunger, so as to subsequently facilitate the nucleic acid detection of the detection tank of the PCR tube 103.

Specifically, in an embodiment, the liquid transferring assembly 50 is further capable of rotating along with the rotating member 41 to a position where the connecting portion 51 is aligned with the plunger hole 107 on the cartridge 100 in the first direction X, and then the connecting portion 51 is inserted into the plunger hole 107 on the cartridge 100 to push the plunger to move when the liquid transferring assembly 50 moves along with the lifting base 31 toward the cartridge 100 in the first direction X. In this way, the connecting portion 51 pushes the plunger to move in the injection tank aligned with the plunger hole 107, so as to inject the nucleic acid-containing liquid in the injection tank into the detection tank of the PCR tube 103.

In this way, after the nucleic acid extraction and the detection prepossessing are completed, and the nucleic acid-containing liquid is transferred into the injection tank, the lifting base 31 moves toward the cartridge 100 along the first direction X until it moves to the third position, so that the liquid transferring assembly 50 enables the tip 106 to be inserted into the corresponding liquid storing tank, and presses the tip 106 to disengage the tip 106 from the connecting portion 51 of the liquid transferring assembly 50. Then, the lifting base 31 is moved to the first position, so that both the liquid transferring assembly 50 and the toggling rod 42 are disengaged from the cartridge 100. Then, the rotating member 41 is controlled to rotate, so as to drive the toggling rod 42 to rotate to a position aligned with the other toggling hole 104 in the first direction X. At this time, the connecting portion 51 of the liquid transferring assembly 50 is aligned with the plunger hole 107. Then, the lifting base 31 is controlled to move toward the cartridge 100 until the toggling rod 42 is inserted into the corresponding toggling hole 104 and the connecting portion 51 is inserted into the plunger hole 107. Then, the rotating member 41 rotates, so that the toggling rod 42 drives the top cover 102 to rotate to the position where the plunger hole 107 is aligned with the injection tank in the first direction X. Then, the lifting base 31 moves toward the cartridge 100 along the first direction X, so that the connecting portion 51 pushes the plunger into the injection tank until the nucleic acid-containing liquid in the injection tank is injected into the detection tank of the PCR tube 103.

Specifically, in an embodiment, two toggling rods 42 are provided. The two toggling rods 42 simultaneously drive the top cover 102 to rotate relative to the cartridge body 101, so that the rotation of the top cover 102 is more stable and reliable. Optionally, the two toggling rods 42 are symmetrically arranged relative to the rotation axis of the rotating member 41.

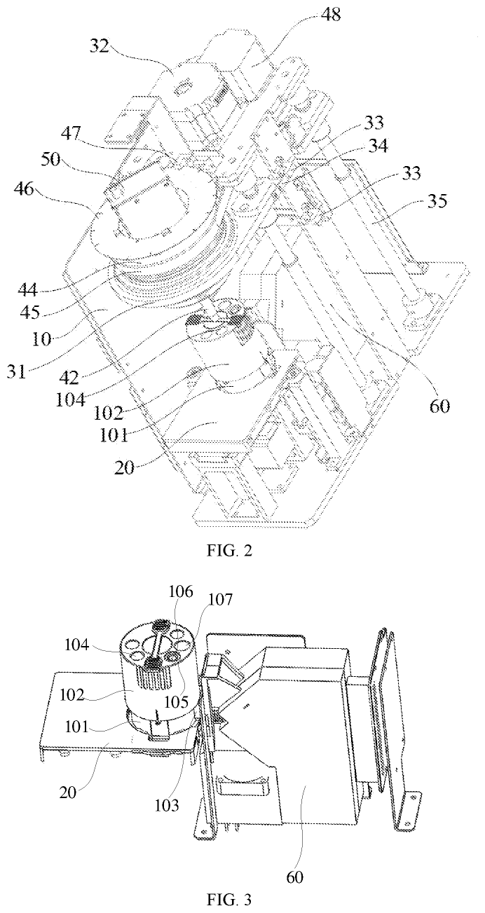

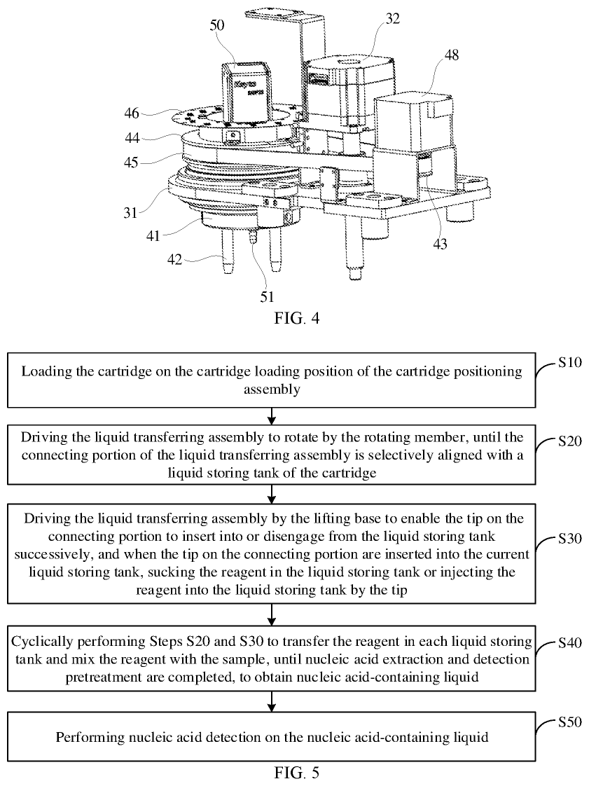

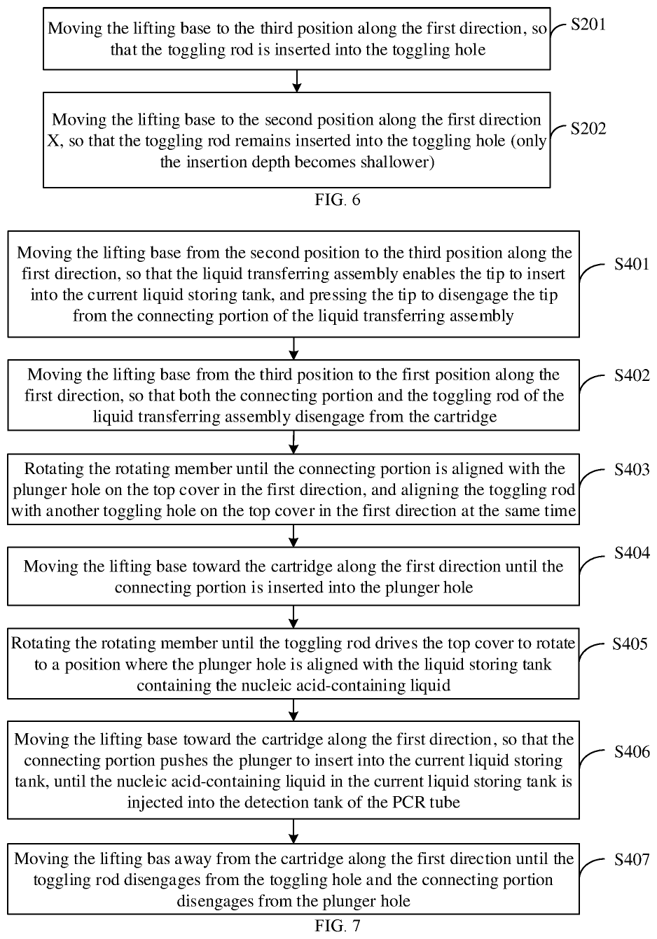

Referring to FIG. 1, FIG. 2 and FIG. 4, in an embodiment, the lifting assembly 30 further includes a driving mechanism 32. The driving mechanism 32 is disposed between the fixing frame 10 and the lifting base 31 to drive the lifting base 31 to move relative to the fixing frame 10 along the first direction X. In this way, the lifting base 31 is driven to move toward or away from the cartridge 100 along the first direction X by the driving mechanism 32.

In an embodiment, the driving mechanism 32 includes a linear driving member mounted on the fixing frame 10. The linear driving member is connected to the lifting base 31 to drive the lifting base 31 to move relative to the fixing frame 10 along the first direction X. Optionally, the linear driving member may be a linear motor or a linear driving module, etc., which is not limited herein.

In another embodiment, the driving mechanism 32 includes a screw rod, a lift driving member, and a nut. The screw rod is rotatably connected to the fixing frame 10 around an axis thereof, and the axis of the screw rod is parallel to the first direction X. The lift driving member is mounted to the fixing frame 10 and is connected to the screw rod to drive the screw rod to rotate around its own axis. The nut is connected to the screw rod, and is fixed to the lifting base 31, so that when the screw rod rotates around its own axis, the nut is driven to move along the axis of the screw rod (that is, along the first direction X), thereby driving the lifting base 31 to move along the first direction X. Optionally, the lift driving member may be a motor.

Specifically, in an embodiment, the lifting assembly 30 further includes a guiding rod 35. The guiding rod 35 is fixed to the fixing frame 10 and extends in the first direction X. The lifting base 31 is slidably connected to the guiding rod 35, so that the guiding rod 35 guides the movement of the lifting base 31 along the first direction X, thereby the movement of the lifting base 31 is more stable and reliable. Optionally, both ends of the guiding rod 35 are fixed to the fixing frame 10, and the guiding rod 35 is assembled to the lifting base 31 through a linear bearing 36.

Further, in an embodiment, at least two the guiding rods 35 are provided, and the lifting base 31 can be guided by the at least two guiding rods 35 at the same time, which is beneficial to improve the guiding effect.

In an embodiment, the rotating assembly 40 further includes a rotary driving mechanism. The rotary driving mechanism includes a rotary driving member 48, a driving pulley 43, a driven pulley 44, and a conveyor belt 45.

The rotary driving member 48 is mounted on the fixing frame 10, and the driving pulley 43 is connected to an output shaft of the rotary driving member 48, so that the rotary driving member 48 can drive the driving pulley 43 to rotate. The driven pulley 44 is mounted on the rotating member 41 and is capable of rotating synchronously with the rotating member 41. The conveyor belt 45 is sleeved between the drive pulley 43 and the driven pulley 44, so that when the rotary driving member 48 drives the drive pulley 43 to rotate, the conveyor belt 45 can drive the driven pulley 44 to rotate, and then the driven pulley 44 drives the rotating member 41 to rotate. In the embodiment, the rotary driving member 48 may be a motor. The driving pulley 43 and the driven pulley 44 may be timing pulleys, and the conveyor belt 45 may be a timing belt.

Specifically, in an embodiment, the rotating member 41 is a cylindrical member, the lifting base 31 has an mounting hole (not shown), and the cylindrical member is sleeved in the mounting hole through a bearing, so that the cylindrical member can rotate relative to the lifting base 31. The driven pulley 44 can be coaxially mounted on the cylindrical member through threaded fasteners (such as bolts, etc.), so that the driven pulley 44 can drive the rotating member 41 to rotate synchronously.

Further, in an embodiment, the toggling rod 42 is fixed to an end of the cylindrical member toward the cartridge 100. The liquid transferring assembly 50 is fixed in an inner cavity of the cylindrical member, and the connecting portion 51 is protruded from the end of the cylindrical member toward the cartridge 100 so as to be engaged with or disengaged from the tip 106.

Specifically, in an embodiment, a code disc 46 is mounted on the rotating member 41, and the code disc 46 has identification configured to identify the position of each liquid storing tank of the cartridge 100. A first photoelectric sensor 47 is provided on the fixing frame 10. The first photoelectric sensor 47 is configured to detect the identification on the code disc 46, which is beneficial to accurately rotate the top cover 102 of the cartridge 100 to a required position, and then accurately inject the reagent into the liquid storing tank or suck the reagent in the liquid storing tank.

Specifically, in an embodiment, the lifting base 31 is provided with a first sensing piece 34. Two second photoelectric sensors 33 are mounted on the fixing frame 10. The two second photoelectric sensors 33 are arranged at intervals along the first direction X, and are configured to detect the first sensing piece 34. During the movement of the lifting base 31 in the first direction X, the first sensing piece 34 is driven to move between the two second photoelectric sensors 33, thereby limiting a maximum travel of the lifting base 31 to move in the first direction X by the two second photoelectric sensors 33.

Based on the above-mentioned device of automatically detecting nucleic acid, the present disclosure also provides a method of detecting nucleic acid using the device of automatically detecting nucleic acid described in any of the above embodiments. The method of detecting nucleic acid includes the following steps.

Step S10: loading the cartridge on the cartridge loading position of the cartridge positioning assembly. Each liquid storing tank of the cartridge is pre-installed with samples and various reagents for nucleic acid extraction and detection pretreatment.

Step S20: driving the liquid transferring assembly to rotate by the rotating member, until the connecting portion of the liquid transferring assembly is selectively aligned with a liquid storing tank of the cartridge. Specifically, when the lifting base 31 is located at the second position, the toggling rod 42 is inserted into the toggling hole 104, and the tip 106 on the connecting portion 51 of the liquid transferring assembly 50 is located in the tip cavity 105. The rotating member 41 drives the toggling rod 42 and the liquid transferring assembly 50 to rotate, so that the toggling rod 42 drives the top cover 102 of the cartridge 100 to rotate until the connecting portion 51 of the liquid transferring assembly 50 is selectively aligned with any liquid storing tank of the cartridge 100.

Step S30: driving the liquid transferring assembly by the lifting base to enable the tip on the connecting portion to insert into or disengage from the liquid storing tank successively, and when the tip on the connecting portion are inserted into the current liquid storing tank, sucking the reagent in the liquid storing tank or injecting the reagent into the liquid storing tank by the tip.

Specifically, the lifting base 31 is moved from the second position to the third position, so that the tip 106 on the connecting portion 51 of the liquid transferring assembly 50 is inserted into the current liquid storing tank. At this time, the liquid transferring assembly 50 injects the reagent into the current storage tank or sucks the reagent in the current storage tank through the tip 106. Then, the lifting base 31 returns from the third position to the second position, so that the toggling rod 42 remains inserted into the toggling hole 104. The tip 106 on the connecting portion 51 disengages from the current liquid storing tank and is located in the tip cavity 105, so that the toggling rod 42 can subsequently drive the top cover 102 to rotate, and the tip 106 does not interfere with the rotation movement of the top cover 102 relative to the cartridge body 101.

Step S40: cyclically performing Steps S20 and S30 to transfer the reagent in each liquid storing tank and mix the reagent with the sample, until nucleic acid extraction and detection pretreatment are completed, to obtain nucleic acid-containing liquid.

Step S50, performing nucleic acid detection on the nucleic acid-containing liquid. Specifically, the nucleic acid detection on the nucleic acid-containing liquid in the detection tank of the PCR tube 103 is performed through the nucleic acid detection module 60.

Specifically, in an embodiment, prior to step S20, the method further includes:

Step S201: moving the lifting base to the third position along the first direction, so that the toggling rod is inserted into the toggling hole. The connecting portion 51 of the liquid transferring assembly 50 is inserted into the tip cavity 105, and presses the tip 106 so that the tip 106 is connected to the connecting portion 51.

Step S202; moving the lifting base to the second position along the first direction X, so that the toggling rod remains inserted into the toggling hole (only the insertion depth becomes shallower). The liquid transferring assembly 50 drives the tip 106 on the connecting portion 51 to disengage from the current liquid storing tank and is located in the tip cavity 105, so that when step S20 is performed, the toggling rod 42 can drive the top cover 102 to rotate, and the tip 106 does not interfere with the rotational movement of the top cover 102 relative to the cartridge body 101.

Specifically in the embodiment, between steps S40 and S50, the method further includes:

Step S401: moving the lifting base from the second position to the third position along the first direction, so that the liquid transferring assembly enables the tip to insert into the current liquid storing tank (at this time, one part of the tip is located in the tip cavity, the other part is inserted into the current liquid storing tank), and pressing the tip to disengage the tip from the connecting portion of the liquid transferring assembly.

Step S402: moving the lifting base from the third position to the first position along the first direction, so that both the connecting portion and the toggling rod of the liquid transferring assembly disengage from the cartridge (that is, the connecting portion of the liquid transferring assembly disengages from the tip cavity, and the toggling rod disengages from the toggling hole).

Step S403: rotating the rotating member until the connecting portion is aligned with the plunger hole on the top cover in the first direction, and aligning the toggling rod with another toggling hole on the top cover in the first direction at the same time.

Step S404: moving the lifting base toward the cartridge along the first direction until the connecting portion is inserted into the plunger hole.

Step S405: rotating the rotating member until the toggling rod drives the top cover to rotate to a position where the plunger hole is aligned with the liquid storing tank containing the nucleic acid-containing liquid (ie, the above-mentioned injection tank).

Step S406: moving the lifting base toward the cartridge along the first direction, so that the connecting portion pushes the plunger to insert into the current liquid storing tank (i.e. the injection tank above), until the nucleic acid-containing liquid in the current liquid storing tank is injected into the detection tank of the PCR tube.

Step S407: moving the lifting bas away from the cartridge along the first direction until the toggling rod disengages from the toggling hole and the connecting portion disengages from the plunger hole.

It should be noted that the specific steps of using the above mentioned device of automatically detecting nucleic acid to conduct experiments are not limited, and different experimental procedures can be formulated as needed. For example, in order to avoid mutual contamination of reagents that do not need to be mixed, a step of replacing the tip 106 can be set after each transferring of the reagent.

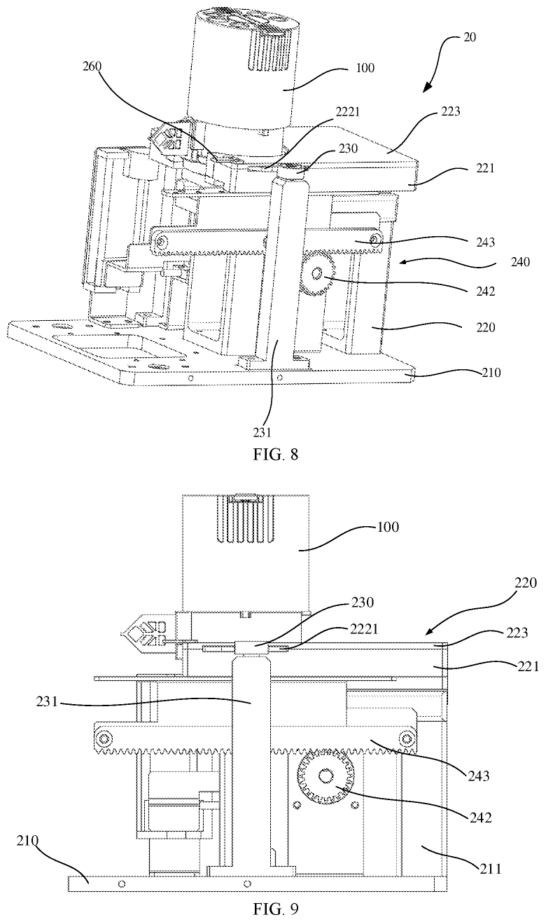

Referring to FIG. 8 to FIG. 10, according to an embodiment, the cartridge positioning assembly 20 includes a base 210, a tray assembly 220, and a driving member 230. The tray assembly 220 includes a tray 221 and a clamping mechanism 222 (shown in FIG. 11). The tray 221 is provided on the base 210, and the clamping mechanism 222 is provided on the tray 221. The tray 221 can be controllably moved relative to the base 10 and can moves between a house-in position and a house-out position. The tray 221 has the cartridge loading position A configured to position the cartridge 100 (shown in FIG. 11). The driving member 230 is provided corresponding to the house-in position, so that when the tray 221 is moved to the house-in position, the driving member 230 abuts the clamping mechanism 222, and provide a force to clamp and fix the cartridge 100 on the cartridge loading position A.

When the cartridge positioning assembly 20 is used, firstly, the tray 221 is located at the house-out position, and the cartridge 100 can be placed on the cartridge loading position A on the tray 221. Then, the tray 221 is controlled to move to the house-in position, and the clamping mechanism 222 clamps the cartridge 100 located at the cartridge loading position A under the force provided by the driving member 230, so that the cartridge 100 is fixed relative to the tray 221. Then the nucleic acid extraction and/or detection on the samples in the cartridge 100 can be carried out. After the nucleic acid extraction and/or detection is completed, the tray 221 can be controlled to move to the house-out position. At this time, the driving member 230 is disengaged from the clamping mechanism 222, so that the clamping mechanism 222 releases the clamping of the cartridge 100 at the cartridge loading position A, and the cartridge 100 can be smoothly removed from the cartridge loading position A, and a new cartridge 100 can be placed on the cartridge loading position A to prepare for a next nucleic acid extraction and/or detection. In this way, when the tray 221 moves to the house-in position and house-out position, the clamping mechanism 222 can automatically clamp or release the cartridge 100 at the cartridge loading position A through the driving member 230. It only needs to place or remove the cartridge 100, which simplifies the operation process of moving to the house-in position and house-out position and reduces the operation difficulty.

It should be noted that, when the tray 221 is moved to the house-in position, the clamping mechanism 222 is capable of fixing the cartridge 100 located at the cartridge loading position A under the force provided by the driving member 230, so that the cartridge 100 is fixed relative to the tray 221, so as to ensure the stability of the cartridge 100 during the nucleic acid extraction and/or detection of the sample in the cartridge 100, which is beneficial to improve the accuracy of nucleic acid extraction and/or detection, and reduce the risk of contamination when the relevant reaction solution is transferred.

Referring to FIG. 11, in an embodiment, the clamping mechanism 222 includes a clamping block 2221 and an elastic member 2222. The clamping block 2221 is movably connected to the tray 221 and can move toward or away from the cartridge loading position A. The elastic member 2222 abuts against the tray 221 and the clamping block 2221. When the tray 221 is moved to the house-in position, the driving member 230 abuts against the clamping block 2221, and pushes the clamping block 2221 to move toward the cartridge loading position A to abut against the cartridge 100, so as to fix the cartridge 100 on the cartridge loading position A. At the same time, the elastic member 2222 provides a resilience force so that the clamping block 2221 has a tendency to move away from the cartridge loading position A, so that the clamping block 2221 can be automatically reset when the force provided by the driving member 230 is withdrawn. When the tray 221 leaves the house-in position, the driving member 230 is disengaged from the clamping block 2221. That is, the force provided by the driving member 230 is withdrawn. At this time, the clamping block 2221 moves away from the cartridge loading position A under the rebound force of the elastic member 2222, so as to disengage from the cartridge 100 at the cartridge loading position A. At this time, the cartridge 100 at the cartridge loading position A can be removed smoothly. Optionally, the elastic member 2222 may be a spring.

Further, in an embodiment, the clamping block 2221 has a first abutting portion (not shown), the tray 221 has a second abutting portion (not shown). One end of the elastic member 2222 abuts against the first abutting portion, and the other end of the elastic member 2222 abuts against the second abutting portion. When the clamping block 2221 moves toward the cartridge loading position A, the first abutting portion is toward the second abutting portion, so that the compression amount of the elastic member 2222 gradually increases. When the clamping block 2221 moves away from the cartridge loading position A, the first abutting portion is away from the second abutting portion, so that the compression amount of the elastic member 2222 gradually decreases. Alternatively, the opposite ends of the elastic member 2222 are sleeved on the first abutting portion and the second abutting portion respectively, so that the elastic member 2222 is compressed when the first abutting portion moves towards the second abutting portion. Of course, in other embodiments, the opposite ends of the elastic member 2222 can also be in direct contact with the first abutting portion and the second abutting portion respectively, as long as the elastic member 2222 is compressed when the first abutting portion moves towards the second abutting portion, which is not limited here.

Specifically, in an embodiment, two clamping mechanisms 222 and two driving members 230 are provided. The two clamping mechanisms 222 are respectively located on opposite sides of the cartridge loading position A, and are in one-to-one correspondence with the two driving members 230.

When the tray 221 moves to the house-in position, the two clamping blocks 2221 are pushed by the corresponding driving member 230 respectively to abut against the cartridge 100, so that two clamping blocks 2221 clamp the cartridge 100 at the opposite sides of the cartridge 100 to fix the cartridge 100.

Further, in an embodiment, the tray 221 moves along a second direction, the two clamping blocks 2221 are located on both sides of the cartridge loading position A along a third direction perpendicular to the second direction. Each clamping block 2221 can move in the third direction relative to the tray 221. When the tray 221 moves to the house-in position along the second direction, the two driving members 230 are located on both sides of the tray 221 along the third direction, and are respectively abuts against the corresponding clamping block 2221, so that the two clamping blocks 2221 can move toward each other along the third direction until the cartridge 100 in the cartridge loading position A is clamped, so as to avoid the cartridge 100 shaking relative to the tray 221. When the tray 221 leaves the house-in position, the two driving members 230 are disengaged from the corresponding clamping block 2221 respectively, and the two clamping blocks 2221 are disengaged from each other in the third direction under the elastic force of the elastic member 2222, thereby the clamping of the cartridge 100 in the cartridge loading position A is released. Specifically, in the embodiment shown in FIG. 11, the second direction is left-right direction, and the third direction is the up-down direction.

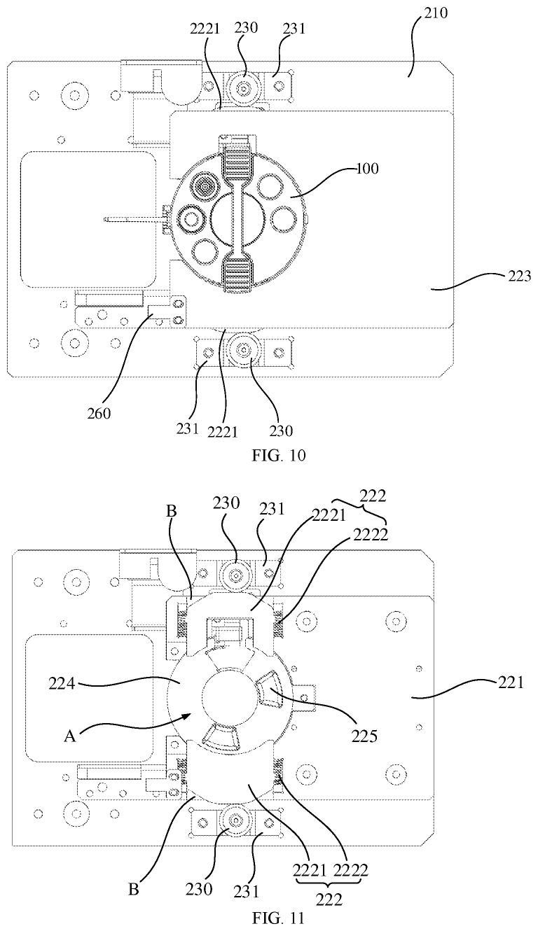

As shown in FIG. 11, in an embodiment, the tray 221 is further provided with two guiding grooves B respectively located on both sides of the cartridge loading position A along the third direction. Each guiding groove B extends along the third direction, and two clamping blocks 2221 are slidably received in the two guiding grooves B respectively. When the tray 221 moves to the house-in position, one end of each clamping block 2221 away from the cartridge loading position A abuts against the driving portion 230, so that the clamping block 2221 moves toward the cartridge loading position A along the guiding groove B until an end of the clamping block 2221 toward the cartridge loading position A enters the cartridge loading position A and abuts the cartridge 100. Further, the tray assembly 220 further includes a cover plate 223 (shown in FIG. 10) provided on the tray 221 to limit the clamping block 2221 in the guiding groove B.

Specifically, in an embodiment, the driving member 230 is a roller. When the tray 221 enters the house-in position, there is rolling friction between the driving member 230 and the clamping block 2221. On the one hand, it is beneficial to reduce the wear between the driving member 230 and the clamping block 2221 and prolong the service life. On the other hand, the tray 221 can smoothly enter or exit the house-in position, so as to prevent the driving member 230 from hindering the movement of the tray 221.

Further, in an embodiment, the side of the clamping block 2221 toward the corresponding driving member 230 is a convex arc surface, so that when the tray 221 enters or leaves the house-in position, the driving member 230 can roll smoothly along the convex arc surface on the clamping block 2221.

Further, in an embodiment, the end of the clamping block 2221 toward the cartridge loading position A has an abutment surface matching with the outer surface of the cartridge 100. For example, when an outer surface of the cartridge 100 is an arc surface, the abutting surface of the clamping block 2221 is also arc-shaped, so that when the abutting surface of the clamping block 2221 is in contact with the cartridge 100, the abutting surface can fit with the outer surface of the cartridge 100, which is beneficial to increase contact area, so that the clamping block 2221 can press and fix the cartridge 100 more stably and reliably.

Further, in an embodiment, the cartridge positioning assembly 20 further includes a supporting base 231. The supporting base 231 is fixed to the base 210. The supporting base 231 can be fixed on the base 210 by screws. Of course, the supporting base 231 can also be fixed on the base 210 by welding, which is not limited herein. The driving member 230 is rotatably connected to the top of the support base 231. Optionally, the rollers may be bearings.

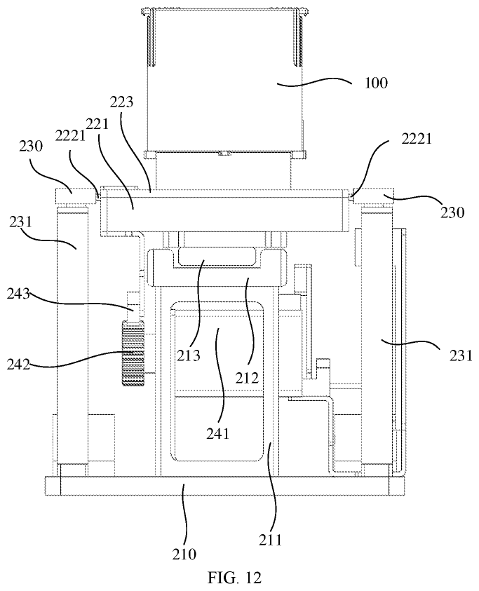

Referring to FIG. 8, FIG. 9 and FIG. 12, in an embodiment, the cartridge positioning assembly 20 further includes a driving assembly 240 provided on the base 210. The driving assembly 240 is capable of driving the tray 221 to move repeatedly between the house-in position and house-out position.

Specifically, in an embodiment, the driving assembly 240 includes a driving element 241, a gear 242, and a rack 243. The driving element 241 is provided on the base 210, and the gear 242 is fixed on an output shaft of the driving element 241, so that the output shaft of the driving element 241 can drive the gear 242 to rotate. The rack 243 is fixed to the tray 221 and engages with the gear 242, so that the rack 243 can drive the tray 221 to move when the gear 242 rotates. That is, the rotary motion output by the driving element 241 is converted into the linear motion of the tray 221 through the engagement of the gear 242 and the rack 243. Optionally, the rack 243 can be fixed on the tray 221 by screws. In other embodiments, the rack 243 can also be welded to the tray 221, which is not limited herein.

Specifically, in an embodiment as shown in FIG. 12, the tray 221 is provided with a sliding block 213, the base 210 is provided with a sliding rail 212, and the sliding block 213 is slidably connected to the sliding rail 212. In this way, the sliding block 213 and the sliding rail 212 are configured to guide the movement of the tray 221, so that the movement of the tray 221 between the house-in position and the house-out position is more stable and reliable. Optionally, the sliding rail 212 is fixed to the base 210 through a fixing base 211. It should be noted that the sliding block 213 and the tray 221 can be fixed by screws or welding. The sliding rail 212 and the fixing base 211 can be fixed by screws or welding. The fixing base 211 and the base 210 can be fixed by screws or welding.

Referring to FIG. 11, in an embodiment, the cartridge positioning assembly 20 further includes a heating bottom plate 224 located below the cartridge loading position A. The heating bottom plate 224 is configured to support the cartridge 100 at the cartridge loading position A and heat the cartridge 100, so that the samples and reagents in the cartridge 100 are within the required temperature range, which is conducive to the nucleic acid extraction and/or detection. Specifically, a heating element, such as an electric heating tube, etc., may be integrated inside the heating bottom plate 224.

Further, in an embodiment, a positioning portion 225 is protruded on the heating bottom plate 224. The cartridge 100 has a positioning groove (not shown) matched with the positioning portion 225. The cartridge 100 can be easily placed in place through the matching between the positioning portion 225 and the positioning groove. A plurality of positioning portions 225 (for example, three positioning portions 225) may be provided. In this case, the cartridge 100 has a plurality of positioning grooves one-to-one corresponding to the positioning portions 225. In other embodiments, the cartridge 100 can be in one-to-one correspondence with the positioning grooves through projections, which is not limited here.

Referring to FIG. 10, in an embodiment, the cartridge positioning assembly 20 further includes a second sensing piece 260 and a first sensor (not shown). The second sensing piece 260 is fixed relative to the tray 221 (e.g., mounted on the tray 221 or the cover plate 223), so as to move together with the tray 221. The first sensor is provided on the lifting base 31 and corresponds to the house-in position, and is configured to detect the second sensing piece 260 at the house-in position. In this way, when the first sensor detects the second sensing piece 260, it indicates that the tray 221 has moved to the house-in position at this time, and the driving element 241 can be controlled to stop running, so that the tray 221 stays at the house-in position, so as to facilitate the nucleic acid extraction and/or detection. Optionally, the first sensor may be a photoelectric sensor, other types of contact sensor or non-contact position sensors.

Specifically, in an embodiment, the cartridge positioning assembly 20 may further include a second sensor (not shown) corresponding to the house-out position, and the second sensor is configured to detect the second sensing piece 260 at the house-out position. In this way, when the second sensor detects the second sensing piece 260, it indicates that the tray 221 has moved to the house-out position at this time, and the driving element 241 can be controlled to stop running, so that the tray 221 stays at the house-out position to enable the cartridge 100 to be removed or replaced. Optionally, the second sensor may be a photoelectric sensor, other types of contact or non-contact position sensors.

In an embodiment, the cartridge positioning assembly 20 further includes a magnetic attracting assembly corresponding to the house-in position. When the tray 221 moves to the house-in position, the magnetic attraction assembly can move toward or away from the cartridge 100 on the cartridge loading position A. When the magnetic attracting assembly moves toward the cartridge 100, magnetic beads in the cartridge 100 can be attracted, so as to realize the nucleic acid extraction. When the magnetic attracting assembly moves away from the cartridge 100, the attraction to the magnetic bead in the cartridge 100 is released.

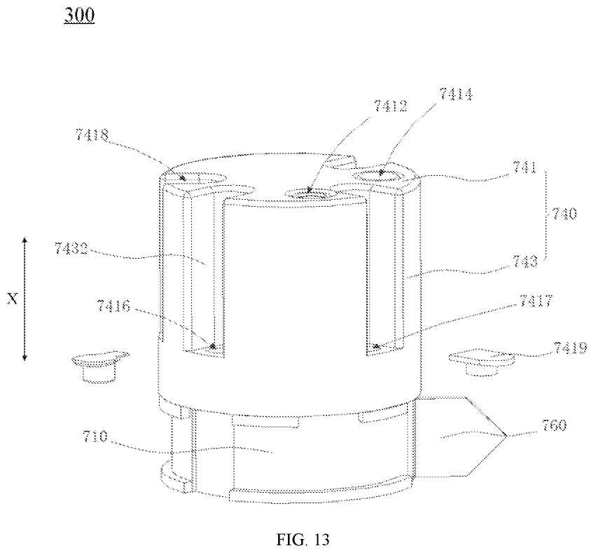

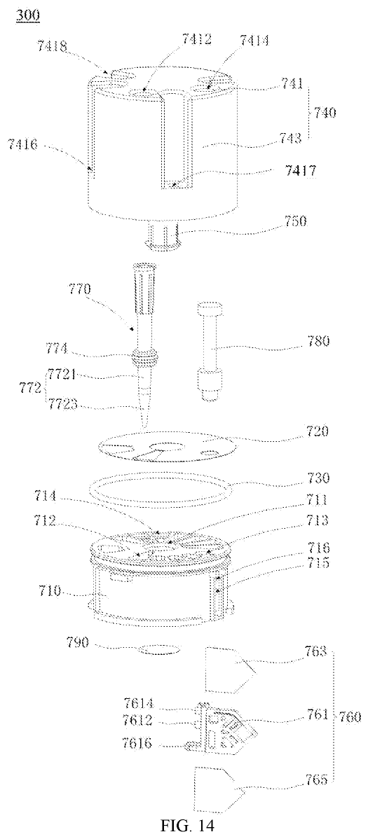

Referring to FIG. 13 and FIG. 14, a cartridge 300 according to another embodiment is mainly configured to extract nucleic acid in a sample. Since the transferring and mixing of all reagents in the nucleic acid extraction process are performed inside the cartridge 300, interference from external factors can be easily eliminated and aerosol pollution can be avoided.

In this embodiment, the cartridge 300 includes a liquid storing assembly 710, a rotating cover 740, a reacting chamber 760, a liquid dispensing member 770, and a second driving mechanism. The liquid storing assembly 710 is configured to store various reagents, the reacting chamber 760 is configured to collect processed samples for polymerase chain reaction. The liquid dispensing member 770 extends to the rotating cover 740 to transfer the reagent in the liquid storing assembly 710. The second driving mechanism is configured to drive the liquid dispensing member 770 to move.

Referring to FIG. 14, in an embodiment, an outer contour of the liquid storing assembly 710 is substantially cylindrical. The central axis of the liquid storing assembly 710 extends along the first direction X shown in FIG. 13. A rotating shaft hole 711 configured to connect to the rotating cover 740 is formed through the center of the liquid storing assembly 710 along the first direction X. An end of the rotating shaft hole 711 away from the rotating cover 740 is sealed by a sealing film 790. An ending surface of the liquid storing assembly 710 adjacent to the rotating cover 740 is provided with a tip chamber 712, an injecting hole 713 and a plurality of liquid storing tanks 714. The tip chamber 712, the injecting hole 713, and the liquid storing tanks 714 surround the rotating shaft hole 711 in the circumferential direction. The tip chamber 712 is configured to accommodate a tip 7723 of the liquid dispensing member 770, the liquid storing tanks 714 are configured to store various reagents. The liquid dispensing member 770 is capable of injecting reagents into the reacting chamber 760 through the injecting hole 713.

Referring to FIG. 15, in an embodiment, the liquid storing tanks 714 include a sample tank 714a, a lysis tank 714b, a proteinase K tank 714c, a magnetic bead tank 714d, a first washing liquid tank 714e, a second washing liquid tank 714f, a third washing liquid tank 714g, an elution tank 714h, a mineral oil tank 714i, a Taq enzyme tank 714j, and a Mix enzyme tank 714k. The cross-section of the liquid storing tank 714 perpendicular to the first direction X (shown in FIG. 13) is substantially fan-shaped. The plurality of liquid storing tanks 714 are distributed at intervals along the circumferential direction of the liquid storing assembly 710. In this way, the user can inject different kinds of reagents into the liquid storing tank 714. It should be understood that the type and quantity of the liquid storing tanks 714 can be provided according to different requirements to meet different experimental requirements.

Referring to FIG. 13, FIG. 14, and FIG. 16, in an embodiment, the outer contour of the rotating cover 740 is substantially cylindrical. The rotating cover 740 includes a top wall 741 and a side wall 743 extending from an edge of the top wall 741 toward the same direction. The rotating cover 740 is sleeved on the liquid storing assembly 710, and the side wall 743 surrounds the liquid storing assembly 710. The cartridge 300 further includes a rotating shaft 750, one end of the rotating shaft 750 is fixed to the top wall 741, and the other end of the rotating shaft 750 extends along the first direction X (shown in FIG. 13) and is rotatably inserted into the rotating shaft hole 711 of the liquid storing assembly 710. In this way, the rotating cover 740 can rotate relative to the liquid storing assembly 710 with the rotating shaft 750 as the rotation axis, so as to drive the liquid dispensing member 770 to rotate around the rotating shaft 750 to be aligned with one of the tip chamber 712, the injecting hole 713 and the plurality of liquid storing tanks 714 in the first direction X.

Further, in an embodiment, the rotating cover 740 is provided with a liquid dispensing member guiding hole 7412. The liquid dispensing member guiding hole 7412 extends from the top wall 741 towards the liquid storing assembly 710. The liquid dispensing member 770 extends through the liquid dispensing member guiding hole 7412 and extends into the tip chamber 712 of the liquid storing assembly 710. In this way, the liquid dispensing member 770 is limited to be located in the liquid dispensing member guiding hole 7412 to rotate with the rotating cover 740, and the liquid dispensing member guiding hole 7412 can guide the liquid dispensing member 770 so that the liquid dispensing member 770 always moves in the first direction X in the liquid dispensing member guiding hole 7412.

Furthermore, in an embodiment, the liquid dispensing member 770 includes a liquid dispensing body 772 and a sealing ring 774. The liquid dispensing body 772 includes a body 7721 and a head portion 7723 connected to one end of the body 7721. The sealing ring 774 is sleeved outside the body 7721 and has an interference fit with the liquid dispensing member guiding hole 7412, thereby sealing the liquid dispensing member guiding hole 7412 to prevent the head portion 7723 from being polluted by an external environment.

When the cartridge 300 is in use, the rotating cover 740 can rotate relative to the liquid storing assembly 710, thereby driving the liquid dispensing member 770 located in the liquid dispensing member guiding hole 7412 to rotate to different positions to be aligned with any one of the tip chamber 712, the injecting hole 713 and a plurality of liquid storing tanks 714 in the first direction X. Therefore, the liquid dispensing member 770 can suck the reagents in different liquid storing tanks 714 or inject the reagents into any one of the liquid storing tanks 714 or the injecting hole 713. Since the above operations are all performed in the cartridge 300, the reagent will not be polluted by the external environment, which can effectively prevent aerosol contamination.

In some embodiments, the cartridge 300 further includes a sealing rod 780 configured to seal the injecting hole 713. Specifically, the rotating cover 740 is provided with a sealing rod guiding hole 7414 extending from the top wall 741 in the first direction X towards the liquid storing assembly 710. The sealing rod 780 extends through the sealing rod guide hole 7414 and can extend into the injecting hole 713 of the liquid storing assembly 710.

Thus, when the extracted sample is injected into the reacting chamber 760 through the injecting hole 713, one end of the sealing rod 780 can be inserted into the reacting chamber 760 to seal the reacting chamber 760. Moreover, during the process of pressing the sealing rod 780 into the reacting chamber 760, uncentrifuged nucleic acid in the reacting chamber 760 is simultaneously pressed into the reacting chamber 760, thereby eliminating the process of centrifugation and quickly adding the nucleic acid sample to the reacting chamber 760. Therefore, the operation process is simplified, the detection time cost is reduced, and the detection efficiency is improved.

In some embodiments, the rotating cover 740 is provided with a sample adding hole 7416 and a MIX TAQ hole 7417. The operator can add reagent into the liquid storing tank 714 through the sampling adding hole 7416 and the MIX TAQ hole 7417. Specifically, the side wall 743 is provided with two grooves 7432 being in communication with the top wall 741, and the sample adding hole 7416 and the MIX TAQ hole 7417 are respectively opened in groove walls at one end of the two grooves 7432 away from the top wall 741. In this way, when the rotating cover 740 rotates to a certain position relative to the liquid storing assembly 710, the sample adding holes 7416 can be aligned with a corresponding liquid storing tank 714, and the operator can add reagents to the liquid storing tank 714 through the sample adding hole 7416. Further, as shown in FIG. 13, the cartridge 300 further includes two sealing covers 7419. The two sealing covers 7419 are configured to seal the sample adding hole 7416 and the MIX TAQ hole 7417 respectively, so as to ensure the tightness of the cartridge 300. The sealing cover 7419 is installed, for example, by heat welding or gluing.

In some embodiments, the rotating cover 740 is also provided with a positioning hole 7418 on the side wall 743. The positioning hole 7418 is in communication with the top wall 741. In this way, the second driving mechanism can drive the rotating cover 740 to rotate relative to the liquid storing assembly 710 through the positioning hole 7418.

The reacting chamber 760 is detachably connected to the side wall of the liquid storing assembly 710 and is in communication with the injecting hole 713. The liquid dispensing member 770 can inject the processed sample into the reacting chamber 760 through the injecting hole 713.

Specifically, referring to FIG. 16, in an embodiment, the liquid storing assembly 710 is provided with a reacting chamber liquid inlet channel 715 and a reacting chamber liquid discharge channel 716. One end of the reacting chamber liquid inlet channel 715 is in communication with the reacting chamber 760, and the other end of the reacting chamber liquid inlet channel 715 first extends away from the reacting chamber 760 in the first direction X, and then extends away from the rotating shaft hole 711 in a radial direction of the liquid storing assembly 710 until it is in communication with the side wall of the liquid storing assembly 710. One end of the reacting chamber discharge channel 716 is in communication with the reacting chamber 760, and the other end of the reacting chamber discharge channel 716 first extends away from the reacting chamber 760 in the first direction X, and then extends away from the rotating shaft hole 711 in the radial direction of the liquid storing assembly 710 until it is in communication with the side wall of the liquid storing assembly 710.

Referring to FIG. 14, in an embodiment, the reacting chamber 760 is detachably connected to the side wall of the liquid storing assembly 710. The reacting chamber 760 has a hollow flat structure, which includes a reacting chamber body 761 and a reacting chamber sealing film. A reacting chamber allowing liquid to flow is provided inside the reacting chamber body 761, and the reacting chamber sealing film is wrapped outside the reacting chamber body 761 to seal the reacting chamber 760. Specifically, in the embodiment, the reacting chamber sealing film includes a first reacting chamber sealing film 763 and a second reacting chamber sealing film 765. The first reacting chamber sealing film 763 and the second reacting chamber sealing film 765 are respectively attached to the two sides of the reacting chamber body 761 and are hot-melt sealed with the reacting chamber body 761. Because the reacting chamber 760 has a flat structure, it has a faster cooling rate, thereby improving the experimental efficiency.

In an embodiment, one end of the reacting chamber body 761 is provided with a reacting chamber liquid inlet pipe 7612 and a reacting chamber liquid discharge pipe 7614. The reacting chamber liquid inlet pipe 7612 and the reacting chamber liquid discharge pipe 7614 are arranged at intervals in the first direction. As shown in FIG. 14 and FIG. 16, when the reacting chamber 760 is inserted into the side wall of the liquid storing assembly 710, the reacting chamber liquid inlet pipe 7612 is in communication with the reacting chamber liquid inlet channel 715, and the reacting chamber liquid discharge pipe 7614 is in communication with the reacting chamber liquid discharge channel 716. In this way, the treated samples can enter the reacting chamber 760 through the injecting hole 713, the reacting chamber liquid inlet channel 715 and the reacting chamber liquid inlet pipe 7612. Gas in the reacting chamber 760 can enter the reacting chamber 760 through the reacting chamber liquid discharge pipe 7614 and the reacting chamber liquid discharge channel 716, so as to maintain the pressure balance in the reacting chamber 760.

In some embodiments, in order to firmly mounted the reacting chamber 760 on the liquid storing assembly 710, two clamping arms 7616 are protruded from one end of the reacting chamber body 761 towards the liquid storing assembly 710. The two clamping arms 7616 are arranged at intervals. The side wall of the liquid storing assembly 710 is provided with two installation slots. Each of the clamping arms 7616 can be deformed recoverably to be clamped in one of the installation grooves. In this way, the reacting chamber 760 is detachably mounted on the liquid storing assembly 710 through the clamping arm 7616.

In some embodiments, the cartridge 300 further includes a liquid storing tank sealing film 720. The liquid storing tank sealing film 720 covers a side of the liquid storing assembly 710 with the liquid storing tank 714 to seal the liquid storing tank 714. In this way, the liquid storing tank sealing film 720 seals the liquid storing tank 714 other than the sample tank 714a to form a sealing environment. When the liquid dispensing member 770 performs sampling, the tip 7723 of the liquid dispensing member 770 can pierce the sealing film 720 of the liquid storing tank and protrude into the sample tank 714a.

The nucleic acid extraction process of the above cartridge 300 is as follows.

The sample chamber 714a is heated to 65° C., and second driving mechanism is connected to the rotating cover 740 through the positioning hole 7418.

The second driving mechanism is inserted into the liquid dispensing member 770 to drive the liquid dispensing member 770 to rise in the first direction X, and then the rotating cover 740 is rotated until the liquid dispensing member 770 is aligned with the lysis tank 714b, and then the liquid dispensing member 770 is controlled to descend in the first direction X to puncture the liquid storing tank sealing film 720, and then the lysis solution in the lysis tank 714b is sucked.

The second driving mechanism drives the liquid dispensing member 770 to rise in the first direction X to leave the lysis tank 714b, and then the rotating cover 740 is rotated until the liquid dispensing member 770 is aligned with the sample tank 714a, the proteinase K tank 714c, and the magnetic bead tank 714d in turn to inject the liquid into the sample tank 714a to mix evenly with the sample. Then, a magnet is used for absorption on the outer wall of the sample tank 714a to absorb for a period of time. The liquid dispensing member 770 sucks the liquid after the absorption, and then the rotating cover 740 is rotated until the liquid dispensing member 770 is aligned with the lysis tank 714b, and the liquid dispensing member 770 injects the liquid into the lysis tank 714b.

Then, the liquid dispensing member 770 and the rotating cover 740 cooperatively transfer the washing solution in the first washing liquid tank 714e, the second washing liquid tank 714f, and the third washing liquid tank 714g to the sample tank 714a to clean the sample tank 714a, and then transfer eluent in the elution tank 714h to the sample tank 714a to mix the eluent with the magnetic beads evenly, and transfer the clarified liquid to the Taq enzyme tank 714j and the Mix enzyme tank 714k after being magnetically sucked.

Finally, the liquid in Mix enzyme tank 714k is transferred to the reacting chamber 760, and then the second driving mechanism presses one end of the sealing rod 780 into the reacting chamber 760, so that the liquid enters the reacting chamber 760 for sealing, so as to complete the extraction of nucleic acid in the sample.

During the above extraction process, the liquid dispensing member 770 is driven to move in the first direction X through the second driving mechanism, and the rotation of the rotating cover 740 is controlled, thereby realizing the transferring of the liquid.

In some embodiments, the cartridge 300 further includes an annular sealing ring 730. The sealing ring 730 is located between the liquid storing assembly 710 and the rotating cover 740 to seal the gap between the liquid storing assembly 710 and the rotating cover 740. In this way, the liquid storing assembly 710 and the rotating cover 740 are relatively rotated in a sealed state, so as to ensure the tightness of the detection process and improve the reliability of the detection result.

When using the above-mentioned cartridge 300, the user only needs to rotate the rotating cover 740 to make the liquid dispensing member 770 extend into different liquid storage tanks 714 to suck or inject reagents, and then transfer the reagents in a closed environment, so as to realize the extraction of nucleic acid, achieve high efficiency of transferring reagents while effectively preventing the interference of external factors. Moreover, the sample can be injected into the reacting chamber 760 through the sealing rod 780, which simplifies the process and improves the detection efficiency.

The foregoing descriptions are merely specific embodiments of the present invention, but are not intended to limit the protection scope of the present invention. Any variation or replacement readily figured out by a person skilled in the art within the technical scope disclosed in the present invention shall all fall within the protection scope of the present invention.

The above-mentioned embodiments do not constitute a limitation on the protection scope of the technical solution. Any modifications, equivalent replacements and improvements made within the spirit and principles of the above-mentioned embodiments shall be included within the protection scope of this technical solution.

What is claimed is:

1. A device of automatically detecting nucleic acid, comprising:
a fixing frame;
a cartridge positioning assembly mounted on the fixing frame and having a cartridge loading position configured to position a cartridge;
a lifting assembly comprising a lifting base provided on the fixing frame, wherein the lifting base is configured to be controllably moved toward or away from the cartridge positioning assembly in a first direction;
a rotating assembly comprising a rotating member provided on the lifting base, wherein the rotating member is capable of controllably rotating relative to the lifting base around a rotation axis parallel to the first direction; and
a liquid transferring assembly mounted on the rotating member and comprising a connecting portion configured to connect to a tip, wherein the liquid transferring assembly is capable of rotating with the rotating member to a position where the connecting portion is aligned with any liquid storing tank of the cartridge in the first direction, the liquid transferring assembly is capable of moving along with the lifting base to an inserting position or a disengaging position in the first direction;
wherein when the liquid transferring assembly is moved to the inserting position, the tip on the connecting portion is inserted into the liquid storing tank of the cartridge, and when the liquid transferring assembly is moved to the disengaging position, the tip on the connecting portion disengages from the liquid storing tank of the cartridge.

2. The device according to claim 1, wherein the rotating assembly further comprises a toggling rod eccentrically mounted on a side of the rotating member facing the cartridge loading position, the toggling rod is capable of moving along with the lifting base in the first direction to a position where the toggling rod is inserted into or disengaged from the cartridge, and when the toggling rod is inserted into the cartridge, the toggling rod is capable of driving the cartridge to rotate along with the rotating member.

3. The device according to claim 2, wherein the liquid transferring assembly is further capable of rotating along with the rotating member to a position where the connecting portion is aligned with a tip cavity of the cartridge in the first direction, and when the liquid transferring assembly is moved along with the lifting base to the inserting position, the connecting portion is capable of engaging with or disengaging from the tip in the tip cavity.

4. The device according to claim 3, wherein the lifting base passes through a first position, a second position, and a third position in sequence during moving towards the cartridge; when the lifting base is positioned in the first position, the toggling rod and the connecting portion are disengaged from the cartridge; when the lifting base is positioned in the second position, the liquid transferring assembly is positioned at the disengaging position, and the toggling rod is inserted into the cartridge; and when the lifting base is positioned in the third position, the liquid transferring assembly is positioned in the inserting position.

5. The device according to claim 3, wherein the liquid transferring assembly is further capable of rotating along with the rotating member to a position where the connecting portion is aligned with a plunger hole of the cartridge in the first direction, and the liquid transferring assembly is capable of moving along with the lifting base toward the cartridge along the first direction to be inserted in the plunger hole, and pushing a plunger in the plunger hole.

6. The device according to claim 1, wherein the lifting assembly further comprises a driving mechanism;
the driving mechanism comprises a linear driving member mounted on the fixing frame and connected to the lifting base, the linear driving member is configured to drive the lifting base to move relative to the fixing frame along the first direction; or
the driving mechanism comprises a screw rod, a lift driving member and a nut, the screw rod is rotatably connected to the fixing frame around an axis thereof, the axis of the screw rod is parallel to the first direction, the lift driving member is mounted to the fixing frame and is connected to the screw rod, and the nut is connected to the screw rod and fixed to the lifting base.

7. The device according to claim 6, wherein the lifting assembly further comprises a guiding rod, the guiding rod is fixed to the fixing frame and extends in the first direction, the lifting base is slidably connected to the guiding rod;
the lifting base is provided with a first sensing piece, two second photoelectric sensors configured to detect the first sensing piece are mounted on the fixing frame, the two second photoelectric sensors are arranged at intervals along the first direction, and during the movement of the lifting base in the first direction, the first sensing piece is driven to move between the two second photoelectric sensors.

8. The device according to claim 1, wherein the rotating assembly further comprises a rotary driving mechanism, the rotary driving mechanism comprises a rotary driving member, a driving pulley, a driven pulley, and a conveyor belt;
the rotary driving member is mounted on the fixing frame, and the driving pulley is connected to an output shaft of the rotary driving member, the driven pulley is mounted on the rotating member and is capable of rotating synchronously with the rotating member, the conveyor belt is sleeved between the drive pulley and the driven pulley.

9. The device according to claim 1, further comprising a nucleic acid detecting module provided on the fixing frame, wherein the nucleic acid detecting module is arranged corresponding to the cartridge and is configured to perform nucleic acid detection on nucleic acid-containing liquid formed in the cartridge.

10. The device according to claim 1, wherein the cartridge positioning assembly comprises:
a base;
a tray assembly comprising a tray provided on the base and a clamping mechanism provided on the tray, wherein the tray is configured to be controllably moved relative to the base to a house-in position and a house-out position, and the cartridge loading position is provided on the tray; and
a driving member provided corresponding to the house-in position, wherein when the tray is moved to the house-in position, the driving member abuts the clamping mechanism and drives the clamping mechanism to clamp the cartridge on the cartridge loading position.

11. The device according to claim 10, wherein the clamping mechanism comprises a clamping block and an elastic member, the clamping block is connected to the tray and is capable of moving toward or away from the cartridge loading position, the elastic member abuts against the tray and the clamping block;
when the tray is moved to the house-in position, the driving member abuts against the clamping block, and pushes the clamping block to move toward the cartridge loading position to abut against the cartridge, and the elastic member provides a resilience force to enable the clamping block to have a tendency to move away from the cartridge loading position.

12. The device according to claim 11, wherein two clamping mechanisms and two driving members are provided, the two clamping mechanisms are respectively located on opposite sides of the cartridge loading position, and are in one-to-one correspondence with the two driving members;
when the tray is moved to the house-in position, the two clamping blocks are pushed by the two driving members correspondingly to clamp the cartridge.

13. The device according to claim 10, wherein the cartridge positioning assembly further comprises a driving assembly provided on the base, and the driving assembly is capable of driving the tray to move between the house-in position and the house-out position.

14. The device according to claim 1, wherein the cartridge comprises:
a liquid storing assembly provided with a tip chamber, an injecting hole, and a plurality of liquid storing tanks on a side thereof;
a rotating cover connected to a side of the liquid storing assembly where the liquid storing tank is provided;
a reacting chamber detachably connected to the liquid storing assembly and being in communication with the injecting hole; and
a liquid dispensing member extending through the rotating cover along the first direction and being capable of reciprocating along the first direction;
wherein the rotating cover is capable of rotating relative to the liquid storing assembly around an axis extending in the first direction to enable the liquid dispensing member to be aligned with and extend into the tip chamber, the injecting hole or any one of the liquid storing tanks in the first direction.

15. The device according to claim 14, wherein the cartridge further comprises a sealing rod extending through the rotating cover along the first direction, and the sealing rod is movable in the first direction to extend into the injecting hole.

16. The device according to claim 14, wherein the cartridge further comprises a rotating shaft, the liquid storing assembly is provided with a rotating shaft hole extending along the first direction, one end of the rotating shaft is connected to the rotating cover, and the other end of the rotating shaft is rotatably connected to the rotating shaft hole.

17. The device according to claim 14, wherein the rotating cover is provided with a sample adding hole, and the sample adding hole is configured to communicate with the liquid storing tank and an external environment.

18. The device according to claim 14, wherein the cartridge further comprises a sealing ring, the sealing ring is provided outside the liquid storing assembly along a circumferential direction and is located between the liquid storing assembly and the rotating cover, and the sealing ring is configured to seal a gap between the liquid storing assembly and the rotating cover.

19. The device according to claim 14, wherein the reacting chamber comprises a reacting chamber liquid inlet pipe and a reacting chamber liquid discharge pipe, the liquid storage assembly is provided with a reacting chamber liquid inlet channel and a reacting chamber liquid discharge channel that are in communication with the injecting holes, respectively;
when the reacting chamber is inserted into the liquid storage assembly, the reacting chamber liquid inlet pipe is in communication with the reacting chamber liquid inlet channel, and the reacting chamber liquid discharge pipe is in communication with the reacting chamber liquid discharge channel.

20. A method of detecting nucleic acid using the device of automatically detecting nucleic acid according to claim 1, comprising:
a, loading the cartridge on the cartridge loading position of the cartridge positioning assembly, wherein, each liquid storing tank of the cartridge is pre-installed with samples and various reagents for nucleic acid extraction and detection pretreatment;
b, driving the liquid transferring assembly to rotate through the rotating member until the connecting portion of the liquid transferring assembly is selectively aligned with a liquid storing tank of the cartridge;
c, driving the liquid transferring assembly through the lifting base to enable the tip on the connecting portion to insert into or disengage from the liquid storing tank successively, and when the tip on the connecting portion are inserted into the liquid storing tank, sucking the reagent in the current liquid storing tank or injecting the reagent into the current liquid storing tank through the tip;
d, performing step b and step c cyclically to transfer reagent in each liquid storing tank and mixing reagents with the sample, until nucleic acid extraction and detection pretreatment are completed to obtain the nucleic acid-containing liquid; and
e, performing nucleic acid detection on the nucleic acid-containing liquid.
